(19) United States
(12) Patent Application Publication
(10) Pub. No.: US 2018/0200799 A1
(43) Pub. Date: Jul. 19, 2018

(54) METHOD OF MANUFACTURING A COMPONENT

(71) Applicant: ROLLS-ROYCE plc, London (GB)

(72) Inventor: Thomas G. MULCAIRE, Derby (GB)

(73) Assignee: ROLLS-ROYCE plc, London (GB)

(21) Appl. No.: 15/864,183

(22) Filed: Jan. 8, 2018

(30) Foreign Application Priority Data
Jan. 13, 2017 (GB) 1700614.9

(51) Int. Cl. B22F 7/06; B22F 3/15; B22F 5/00; B29B 11/12; B29C 43/00; B29C 43/18; B28B 3/00

(52) U.S. Cl. CPC B22F 7/064; B22F 3/15; B22F 5/008; B29B 11/12; B29L 2031/748; B29C 43/18; B28B 3/003; B29C 2043/189; B29C 43/006

(57) ABSTRACT

A method of manufacturing a component (100) having a main part (101) and a projecting feature (104,114), the method comprising providing a shaped void (210) corresponding to the component, locating a pre-formed element (214) in a feature region of the shaped void which corresponds to the projecting feature, locating powder (212) within the shaped void; and forming the element and the powder into the component such that the element creates at least a part of the projecting feature.

### CROSS-REFERENCE TO RELATED APPLICATION

This application is based upon and claims the benefit of priority from British Patent Application No. 1700614.9 filed 13 Jan. 2017, the entire contents of which are incorporated herein.

### FIELD OF DISCLOSURE

The present disclosure concerns a method of manufacturing a component and in particular, although not exclusively, a method of forming a component using hot isostatic pressing.

### BACKGROUND

It is known to form manufacture components from powdered materials, such as powdered metals or ceramics. A number of methods are available to form solid components from powders, and the chosen method depends upon the required properties of the component and the available budget. For example, sintering is a cheaper and simpler method of forming a component from powder, whilst hot isostatic pressing (HIP) is more expensive and complex but forms a component having improved mechanical properties when compared to the same component formed by sintering.

Powder forming components has inherent difficulties, particularly in relation to producing net-shape or near-net-shape conditions of supply (COS). As the arrangement and conglomeration of the powder can sometimes be non-uniform, some parts of the component may be denser than others or may reduce in volume to a greater extent than others during forming. This can mean that further machining operations may be required to put the codsamponent in net-shape or near-net-shape COS, which can be an inefficient use of time, money, and resources.

GB2412949 provides a turbine stator casing which comprises a housing and fastening hooks projecting from an inner face of the housing for fastening nozzle or guide vanes thereto. The housing is made of a first alloy by hot isostatic compression, using a metal powder, and the fastening hooks are made of second alloy, which is more refractory than the first alloy, and are secured to the housing by diffusion welding during the hot isostatic compression. The second alloy may comprise nickel and/or cobalt. The application also provides a method of manufacturing the turbine stator casing using a destroyable mould.

US2004/06956 describes filtering candles comprising a sintered filtering tube and a cast iron collar which is connected thereto. The collar comprises an annular collar wall which is oriented towards the filtering tube from the neck. Said wall comprises at least one recess which is arranged in a perpendicular manner and at an angle in relation to a plane which is perpendicular to the axis of the filtering tube.

U.S. Pat. No. 4,097,276 describes a turbine wheel having a plurality of blades radiating from a central hub which is manufactured by assembling a plurality of preformed ceramic or superalloy blades into a ring with foot portions on the blades projecting into the central region of the assembly, filling such central region with powdered ceramic material, such as silicon carbide, or a superalloy material, heating and isostatically pressing at least the central region to compact the powdered material around the foot portions into a unitary hub.

U.S. Pat. No. 4,855,103 describes a method of manufacturing metal products from a powder which is received in a mould cavity formed by a gas-tight casing and is isostatically hot pressed in the casing to form a monolithic body. A body of graphite, hexagonal boron nitride, or another similar ceramic material is provided as a core in the mould cavity, and after the isostatic hot pressing this core is removed from the produced monolithic body by blasting.

### BRIEF SUMMARY

The present disclosure seeks to provide an improved method for forming components from a powder.

The present disclosure provides a method of manufacturing a component according to the appended claims.

Described herein is a method of manufacturing a component having a main part and a projecting feature, the method comprising providing a shaped void corresponding to the component, locating a pre-formed element in a feature region of the shaped void corresponding to the projecting feature; placing a powder into the shaped void, and forming the element and the powder into a conglomerated the component such that the element creates at least a part of the projecting feature.

Further described is a method of manufacturing a component having a main part and a projecting feature, the method comprising: providing a shaped void corresponding to the component within a canister, the shaped void further comprising a recess to provide a feature region for receiving a pre-formed element to provide the projecting feature; locating the pre-formed element in the feature region of the shaped void which corresponds to the projecting feature such that the pre-formed element only partially fills the feature region such that it can be surrounded by powder within the feature region; locating powder within the shaped void and around the pre-formed element within the feature region; and forming the element and the powder into the component such that the element creates at least a part of the projecting feature.

The shaped void may comprise an annular gap between a first and second canisters or parts. The recess may have a first thickness corresponding to the projecting feature, and a second region having a second thickness less than the first thickness corresponding to the main part.

The element and the powder may be formed into the component using a hot isostatic pressing process. The element and powder may be formed into the component using a sintering process, or a cold isostatic pressing process.

The element and powder may be formed into a conglomerated or amalgamated component. Following the forming, the element and powder may be combined such that any interface between the portion of the component formed by the element and the powder are indistinguishable.

The element may be formed of the same or substantially the same material as the powder. The element may be a solid mass of material. The element may also be known as an insert. It should be understood that “solid” in the context of the present disclosure may mean a non-particulate solid. The element may be a contiguous mass of material. The powder may be a metal powder, a metal alloy powder, a ceramic powder, or a polymeric powder. The material of the element may be non-soluble or may have equal solubility to the powder or the material of the powder.

The element may be shaped such that a depth of the powder between the element and a wall of the shaped void is substantially constant.

The shaped void may comprise a region having a first thickness corresponding to the projecting feature, and a second region having a second thickness less than the first thickness corresponding to the main part. The shaped void may comprise an annular gap between first and second canisters or parts. The shaped void may further comprise a recess comprising the feature region for receiving the element and for forming the projecting feature. The projecting feature may be a boss or duct of the component.

The boss or duct may comprise a bore from an interior to an exterior of the component. The element may comprise a bore cavity which forms a part of the bore. The bore cavity may partially form a bore. The method may further comprise completing a partially formed bore through the component with a further machining operation.

The component may be an aerospace component. An aerospace component may be a component for forming a part of an aircraft, such as a fixed wing aircraft or a rotary aircraft, such as a helicopter.

The component may be an engine casing, such as a gas turbine engine casing. The element may form a portion of a boss or duct of the engine casing.

The method may further comprise forming the element by hot isostatic pressing. The element may also be formed by sintering, machining, casting, or extrusion.

The element may supported in the feature region by one or more support members. The or each support member may be in contact with a wall of the shaped void. The or each support member may be elongate, such as a pins or a leg. The or each support member may be formed as part of the element, or may be a separate part. The or each support member may be formed of the same material as the element or the powder.

The component may have a plurality of projecting features and a pre-formed element may be located in each of a plurality of feature regions of the shaped void corresponding to the plurality of projecting features.

The method may be a method of reducing local deformations or deviations in reduction in volume during the manufacture of a component by hot isostatic pressing.

The present disclosure may also provide an apparatus for forming a component comprising a shaped void corresponding to a component, a pre-formed element for locating in the shaped void and a powder for filling a remaining volume of the shaped void. The shaped void may be formed by an inner canister and an outer canister. The pre-formed element may contact the canister within the shaped void. Alternatively, the pre-formed element may be encapsulated by the powder on all sides such that it does not contact the canister.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

Examples will now be described, with reference to the Figures, in which:

FIG. 1 is a sectional side view of a gas turbine engine;

FIG. 2 is a sectional view of a component;

FIG. 3 is a sectional view of an apparatus for manufacturing a component;

FIG. 4 is a sectional view of an apparatus for manufacturing a component;

FIG. 5 is a sectional view of a portion of an apparatus for manufacturing a component;

FIG. 6 is a sectional view of a portion of an apparatus for manufacturing a component; and

FIG. 7 is a sectional view of a portion of an apparatus for manufacturing a component;

### DETAILED DESCRIPTION OF THE DRAWINGS AND EMBODIMENTS

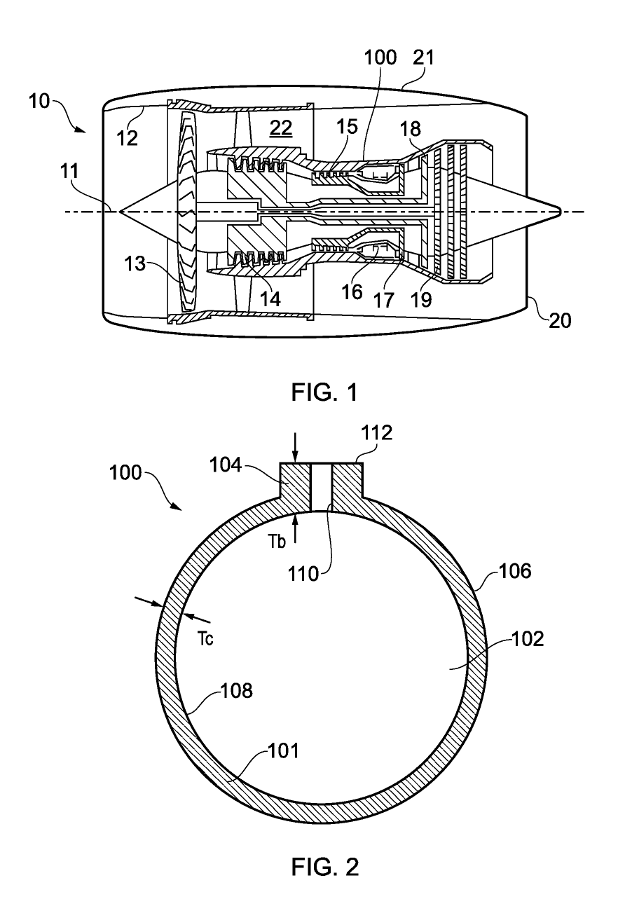

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19, and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate, and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14, and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The gas turbine engine comprises an engine casing 100 which houses the compressors 14, 15, the combustion equipment 16, and the turbines 17, 18, 19. The engine casing 100 is generally cylindrical, and may be formed of multiple casing sections of different diameters sized according to the respective part of the engine contained therein.

Turning now to FIGS. 2, 3, and 4, a method of manufacturing a component, in particular a casing 100, will be described.

As shown in FIG. 2, the casing 100 forms an annulus having a central passage 102 in which the engine components (not shown) are located. The casing 100 has an exterior annular surface 106 and an interior annular surface 108 with a radial thickness Tc therebetween about the majority of the circumference of the casing 100, which may be known as the main body or main part of the casing 101. The casing 100 also comprises a projecting feature 104 in the form of a boss 104 on its exterior surface 106, which comprises a bore 110 between the exterior 106 and interior 108 surfaces. In some cases, the boss may not comprise a bore. The boss 104 is a region of the casing 100 having an increased thickness such that a flat boss surface 112 is formed for fixing the casing 100 to other components or to facilitate fixing of other components, such as pipes and valves to the casing.

The casing 100 has an area of increased thickness to form the boss 104. In order to form the flat boss surface 112, the boss thickness Tb varies across the width of the boss due to the curvature of the casing 100. The boss thickness Tb is greater than the general casing thickness Tc across the entire boss 104, but the boss thickness Tb is at a maximum at the outer edges of the boss surface 112 due to the curvature of the casing 100.

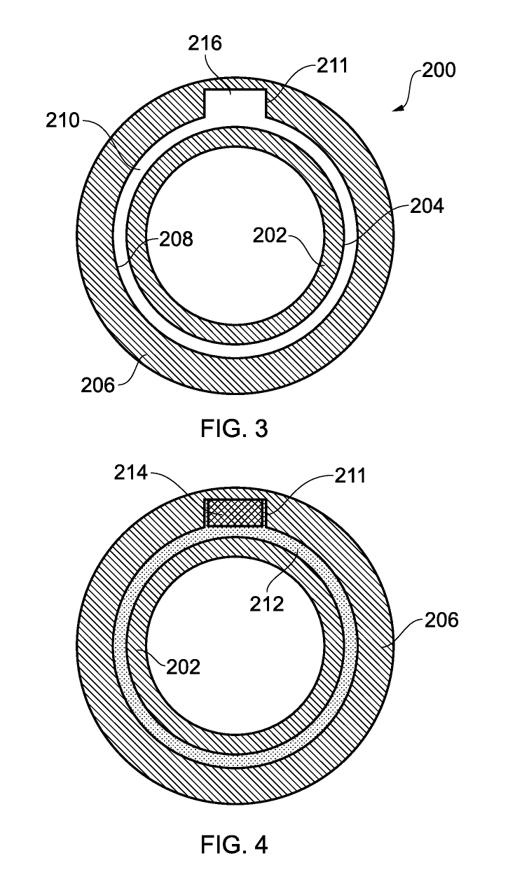

Shown in FIG. 3 is an apparatus 200 for forming the casing 100. The apparatus 200 comprises an inner canister 202 having an outer surface 204 for forming the interior surface 108 of the casing 100 and an outer canister 206 having an inner surface 208 for forming the exterior surface 106 of the casing 100. The outer canister 206 also has a recess 211, defining a feature region, formed in its inner surface for forming the boss 104 of the casing 100. When the inner canister 202 is arranged inside the outer canister 206, a shaped void 210 is formed between the two canisters 202, 206. The shaped void 210 is a mould which corresponds to the shape of the casing 100. The canisters 202, 206 are capped at their axial ends to close off the void 210.

An aperture (not shown) is provided in either the inner or outer canister to allow powder 212 to be fed into the void 210. The powder 212 is a fine particulate of the material from which the casing 100 will be formed. In the present case, the powder 212 is a metallic powder, but it will be understood that the powder could be formed from other materials, such as ceramics or polymers. Although the powder 212 is formed of solid particles, the term ‘solid’ used herein should be understood to mean a unitary solid which is not a particulate.

Referring to FIG. 4, to manufacture the casing 100, a pre-formed element or insert 214 is located in the recess 211 of the shaped void 210. Powder 212 is then fed into the void 210 via the aperture under a vacuum until the shaped void 210 is filled with powder 212 as shown in FIG. 4. The pre-formed element 214 is slightly smaller than the feature region defined by the recess 211 and therefore some powder 212 is located between the element 214 and the outer canister 206. Of course, even though the void 210 is full with powder 212, as the powder 212 is a particulate, a small amount of empty space will remain in the void 210 due to small voids between powder particles.

Once the void 210 is filled with powder 212, the aperture is sealed, and so the void 210 is made airtight. The canisters 202, 206 are then places in a pressure vessel and heated at high temperature and pressure for a predetermined period of time. The powder 212 in the void is compressed and heated during this hot isostatic pressing (HIP) process such that it amalgamates into a solid component.

Once the heat and pressure cycle is complete, the powder 212 and the pre-formed element 214 is amalgamated or conglomerated into a contiguous solid casing 100 comprising the main body and the boss 104. The canisters 202, 206 are then removed using machining techniques, acid etching, or a combination thereof. As the HIP occurs, the powder 212 reduces in volume as the voids therebetween are compressed. The reduction may be either randomised about the component, or may be a constant percentage reduction in the volume compared to the original size of the void 210.

However, since the pre-formed element 214 is already a solid mass, it will not reduce in volume during the HIP process like the powder 212. Thus the element 214 serves to reduce local volumetric reduction due to the compression of the powder 212. This can reduce a dishing effects in thicker areas of the casing 100 which can occur when performing powder-only HIP. As the element 214 is of the same material as the powder 212, the powder and the element amalgamate or conglomerate into a single homogenous piece during the HIP process such that no boundary is present between them in the finished casing 100. Thus, by combining powder 212 with a pre-formed element 214 in the void 210, a casing 100 having the desired mechanical properties can be obtained with the HIP process without extensive further machining required due to non-uniform volume reduction or ‘dishing’. The element 214 itself may be formed by a HIP process. Alternatively, the element 214 may be formed by other means, such as casting, sintering, or machining from bar.

In FIG. 4, the element 214 is a cuboid which is located against the recess boss surface 216. Of course, it should be understood that the shape of the element 214 can be adjusted to suit the shape of the boss 104 and in order to ensure uniform thickness of powder 212 throughout the void 210.

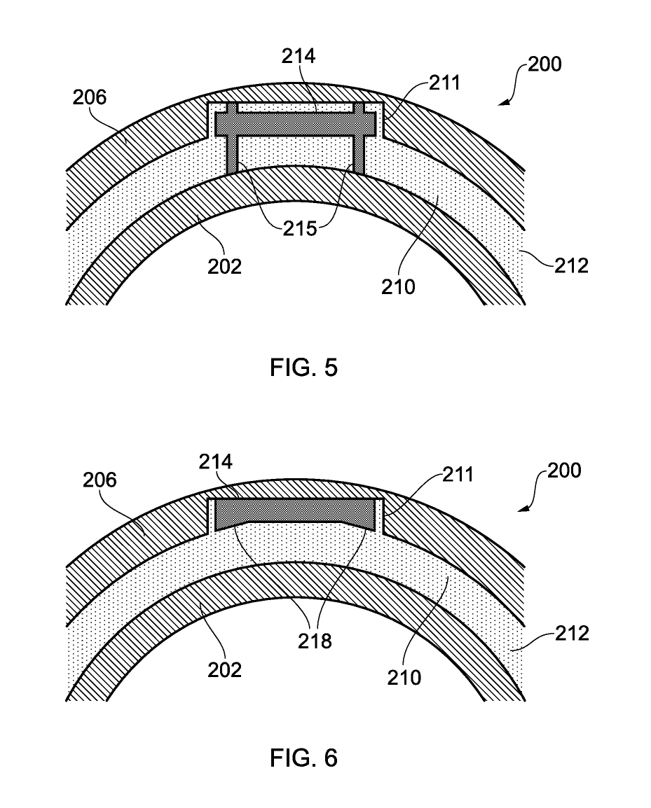

Various other elements 214 are shown in FIGS. 5, 6, and 7.

As shown in FIG. 5, the element 214 may be located in a centralised position in the recess 211 and the void 210 such that it does not touch either of the canisters 202, 206 and will form an internal portion of the canister 100. Other shapes of elements 214 could also be used, such as elements which also extend into the main void 210 outside of the recess 211, between the outer and inner canisters 202, 206, or into the inner canister 202 itself depending on the nature of the casing 100 and boss 104 required.

Any of the elements 214 shown herein may be held in place using pins 215 as shown in FIG. 5. Alternatively, in one method the void 210 may be partially filled with powder 212, the element 214 may be appropriately located and supported by the powder 212, and then the remaining powder 212 may be poured to fill the void 210.

In a further arrangement shown in FIG. 6, the element 214 may have a more complex shape than the cuboidal cross-sections shown in FIGS. 4 and 5 to further counteract dishing effects. In this embodiment, the element 214 is shaped with a thicker through-section at its edge portions 218. When located in the void 210, the edge portions 218 are located in the void 210 where the boss 104 has the greatest depth due to the curvature of the casing 100. If the flat-bottomed elements of FIG. 4 or 5 are used, the thickness of powder 212 between the inner canister 202 and the element 214 varies across the width of the element. In contrast the element 214 of FIG. 6 maintains a substantially uniform thickness of powder in the proximity of the element 214 to provide more uniform volumetric reduction during HIP and, consequently, reduced dishing.

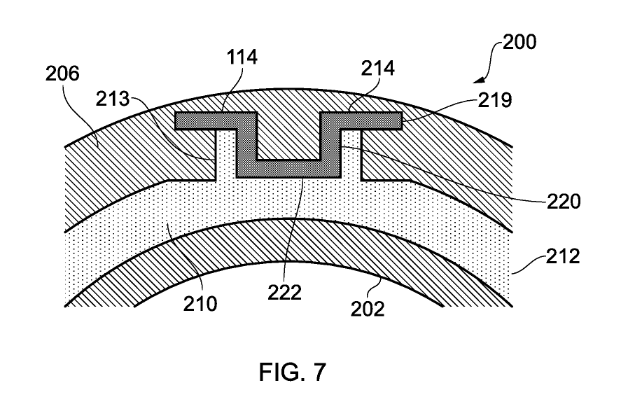

FIG. 7 shows a further alternative example, whereby a projecting feature in the form of a duct 114 may be formed on a casing 100 instead of a boss using the techniques of the present disclosure. In the arrangement of FIG. 7, the outer canister 206 has a duct recess 213 formed in its inner surface 208. The duct recess 213 comprises two elongate ‘L’ shaped recesses. The shape of the duct recess 213 may make it difficult to ensure that powder 212 is completely filling the recess 213. Furthermore, even if the recess 213 is successfully filled with powder 212, volumetric reduction during HIP may result in a malformed or warped duct 114. Therefore, the element 214 in FIG. 7 is a duct element. The element conforms substantially to the shape of the duct recess 213 such that it is not necessary to fill the recess with powder. The element 214 has duct flange portions 219, which form the flanges of the duct 114, radially extending duct wall portions 220, and a conjoining portion 222 which connects the two duct wall portions. The duct wall portions 220 are thinner than the width of the duct recess 211 such that powder 212 can be flowed partially into the duct recess 211 to ensure complete amalgamation of the powder 212 and the element 214 during HIP.

Any of the elements described herein may further comprise a bore cavity for forming or partially forming a bore through the casing 100. For example, the outer canister 206 of FIG. 7 could extend through a cavity in the conjoining portion 222 of the element 214 and contact the inner canister 202 such that when the canisters 202, 206 are removed, a bore is present through the casing 100.

It should be understood that multiple elements 214 may be utilised to form a casing 100, particularly where multiple bosses 104 or ducts 114 are required.

It should also be understood that the present methods are not only applicable to aerospace applications such as gas turbine engine casings. The present methods may be used in other fields for reducing dishing in any component produced using HIP.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method of manufacturing a component having a main part and a projecting feature, the method comprising:
providing a shaped void corresponding to the component within a canister, the shaped void further comprising a recess to provide a feature region for receiving a pre-formed element to provide the projecting feature;
locating the pre-formed element in the feature region of the shaped void which corresponds to the projecting feature such that the pre-formed element only partially fills the feature region such that it can be surrounded by powder within the feature region;
locating powder within the shaped void and around the pre-formed element within the feature region; and
forming the element and the powder into the component such that the element creates at least a part of the projecting feature.

2. A method as claimed in claim 1, wherein the shaped void comprises an annular gap between a first and second canisters or parts.

3. A method as claimed in either of claim 1, wherein the recess has a first thickness corresponding to the projecting feature, and a second region having a second thickness less than the first thickness corresponding to the main part.

4. A method as claimed in claim 1, wherein the pre-formed element and the powder are formed into the component using a hot isostatic pressing process.

5. A method as claimed in claim 1, wherein the pre-formed element is formed of substantially the same material as the powder.

6. A method as claimed in claim 1, wherein the pre-formed element is shaped such that a depth of the powder between the pre-formed element and a wall of the shaped void is substantially constant.

7. A method as claimed in claim 1, wherein the projecting feature is a boss or duct of the component.

8. A method as claimed in claim 7, wherein the boss or duct comprises a bore from an interior to an exterior of the component, and wherein the element comprises a bore cavity which forms at least a part of the bore.

9. A method as claimed in claim 1, wherein the component is an aerospace component.

10. A method as claimed in claim 9, wherein the component is an engine casing, and wherein the projecting feature is a boss or duct of the engine casing.

11. A method as claimed in claim 1, further comprising forming the pre-formed element using hot isostatic pressing.

12. A method as claimed in claim 1, wherein the pre-formed element is supported in the feature region by one or more support members of the element.

13. A method as claimed in claim 12, wherein the one or more support elements contact the canister.

14. A method as claimed in claim 1, wherein the component has a plurality of projecting features, and wherein the pre-formed element is located in each of a plurality of feature regions of the shaped void corresponding to the plurality of projecting features.

15. A method as claimed in claim 1, wherein the pre-formed element contacts the canister within the shaped void.

16. A method as claimed in claim 1, wherein the pre-formed element is encapsulated by the powder on all sides such that it does not contact the canister.
